(19) United States
(12) Patent Application Publication
(10) Pub. No.: US 2011/0289154 A1
(43) Pub. Date: Nov. 24, 2011

(54) ONLINE CHATTING SYSTEM AND METHOD FOR USER CONNECTED TO WEBSITE

(75) Inventor: Yong Jung Bang, Daegu (KR)

(73) Assignee: LOG CORP., Daegu (KR)

(21) Appl. No.: 12/782,922

(22) Filed: May 19, 2010

(51) Int. Cl. G06F 15/16

(52) U.S. Cl. 709/206

(57) ABSTRACT

An online chatting method for a user connected to a website includes (a) receiving information on a TCP socket server by a user client when the user client accesses a web page offered by a web server, (b) accessing the TCP socket server by the user client by using the information on the TCP socket server, (c) if the user client is allowed to access the TCP socket server, transmitting and receiving chatting messages to/from an operator client through the TCP socket server and (d) if the user client fails to access the TCP socket server, storing the chatting messages to be transmitted to the operator client through in a database and periodically receiving the chatting messages stored in the database by the operator client.

### FIELD OF THE INVENTION

The present disclosure relates to a system and a method for providing chatting function to a user connected to a website. More particularly, the present disclosure relates to a system and a method for providing an online chatting function between a website operator and a user connected to a website by selecting a web server or a TCP socket server depending on whether or not there is a firewall without a program installation or log-on.

### BACKGROUND OF THE INVENTION

As use of the Internet has been increasing and information obtainable through the Internet has been also increasing, activities of Internet communities have been growing. In particular, it is often that Internet users visit a website and obtain information from the website.

Accordingly, it is often that an enterprise creating its own home page for marketing provides various kinds of information to a user connected to the home page through the home page.

However, such information is provided through the home page in a one-way direction, and, thus, the user connected to the website can obtain only the provided information and it is not easy for the user connected to the website to ask a website operator for further information.

Recently, a chatting system has been provided to a user connected to a website.

In accordance with a conventional chatting system, in order for a user connected to a website to use contents, a community, or consulting, the user is requested to enter his/her own ID registered in a database. Particularly, it is required for a user who just wants to use information on the website to register his/her own ID.

In accordance with the conventional chatting system, only after a user logs-on to a website, a means for exchanging messages between users connected to the website is provided to the user or an executive program is installed on a client device of the user connected to the website. Even if a additional program is not needed to be installed, only after the user logs-on to the website, a chatting function is provided to the user.

In this way, in the conventional chatting system, a user is requested to install a additional program or to log on to a web site using his/her own ID registered in the database of the website.

Therefore, the user should put up with inconvenience of installing the additional program or logging-on to the website in order to use the chatting function provided from the website.

### BRIEF SUMMARY OF THE INVENTION

In accordance with an embodiment of the present invention, there are provided a method and a system for providing an online chatting function by providing an online chatting service through either a TCP socket server or a web server depending on whether or not an access to the TCP socket server is blocked by a firewall.

In view of the foregoing, the present disclosure provides an online chatting method for a user connected to a website including (a) receiving information on a TCP socket server by a user client when the user client accesses a web page offered by a web server, (b) accessing the TCP socket server by the user client by using the information on the TCP socket server, (c) if the user client is allowed to access the TCP socket server, transmitting and receiving chatting messages to/from an operator client through the TCP socket server, and (d) if the user client fails to access the TCP socket server, storing the chatting messages to be transmitted to the operator client in a database and periodically receiving the chatting messages stored in the database by the operator client. The information on the TCP socket server may includes an IP (Internet Protocol) address and a port number of the TCP socket server.

In the above-mentioned online chatting method, a chatting window where the chatting messages are inputted may be displayed on the web page by a script inserted into the web page.

In the above-mentioned online chatting method, the step (d) may include: (d1) receiving an ID (Identification) from the web server; (d2) transmitting the ID and the chatting messages to the web server; and (d3) periodically receiving the chatting messages which are related to the ID and stored in the database by the operator client.

In the above-mentioned online chatting method, the ID may be inserted into a session of the user client and may be assigned to the user client.

In the above-mentioned online chatting method, the ID may be stored in userData file which is configured to store data in the user client and to read the stored data from the user client by using userData Behavior.

In the above-mentioned online chatting method, the ID may be stored in flash data file which is configured to store data in the user client and to read the stored data from the user client by using SharedObject class of Macromedia Flash.

Further, the present disclosure provides an online chatting system including a TCP socket server connected to a user client and an operator client through a predetermined port and a web server connected to the user client and the operator client through a HTTP connection port, wherein if a connection between the user client and the TCP socket server is not blocked by a firewall, the user client and the operator client perform an online chatting by exchanging chatting messages in real time through the TCP socket server, if a connection between the user client and the TCP socket server is blocked by the firewall, each of the user client and the operator client stores chatting messages in a database, and each of the operator client and the user client periodically receives the chatting messages stored in the database, and the web server provides information on the TCP socket server including an IP address and a port number of the TCP socket server to the user client.

In the above-mentioned online chatting system, the web server may include: an ID (identification) generating unit that generates an ID corresponding to the user client; a database that stores the chatting messages received from the user client and the operator client, together with the ID; and a chatting message managing unit that periodically provides the chatting messages stored in the database to the user client and the operator client.

The above-mentioned online chatting system may further include: a session generating unit that generates a session with respect to the user client and inserts the ID into the session.

In the above-mentioned online chatting system, the ID may be stored in userData file which is configured to store data in the user client and to read the stored data from the user client by using userData Behavior.

In the above-mentioned online chatting system, the ID may be stored in flash data file which is configured to store data in the user client and to read the stored data from the user client by using SharedObject class of Macromedia Flash.

In accordance with the present disclosure, if a user client is connected to a TCP socket server, the user client may send and receive a message to/from an operator client. Therefore, it is possible to provide a real-time online chatting service with less load at high speed to the user client and the operator client.

In accordance with the present disclosure, if the user client is not connected to the TCP socket server, the user client and the operator client may transmit chatting messages to a web server so as to be stored in a database of the web server, and periodically receives the stored messages. Therefore, the online chatting service can be provided regardless of whether or not there is a firewall.

### BRIEF DESCRIPTION OF THE DRAWINGS

The disclosure may best be understood by reference to the following description taken in conjunction with the following figures:

FIG. 1 is a schematic view of an online chatting system for a user connected to a website in accordance with an embodiment of the present disclosure;

FIG. 2 shows a system which provides online chatting to a user connected to a website depending on whether or not there is a firewall in accordance with an embodiment of the present disclosure;

FIG. 3 is a flowchart showing an online chatting method for a user connected to a website in accordance with an embodiment of the present disclosure;

FIG. 4 is a flowchart showing an online chatting method through a polling connection in accordance with an embodiment of the present disclosure;

FIG. 5 is a block diagram showing a configuration of a web server of an online chatting system for a user connected to a website in accordance with an embodiment of the present disclosure; and

FIG. 6 shows a screen of a website in which online chatting function is provided to a user and displayed on a browser of a user client in accordance with an embodiment of the present disclosure.

### DETAILED DESCRIPTION OF THE INVENTION

Hereinafter, embodiments of the present invention will be described in detail with reference to the accompanying drawings so that the present invention may be readily implemented by those skilled in the art. However, it should be noted that the present invention is not limited to the embodiments but can be implemented in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

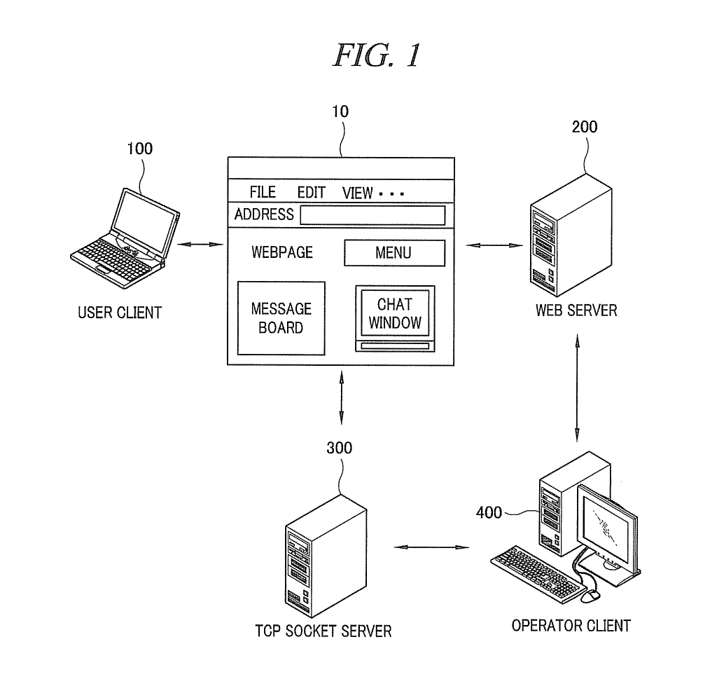

FIG. 1 is a schematic view of an online chatting system for a user connected to a website in accordance with an embodiment of the present disclosure.

A user client 100 is connected to a web server 200 through a wired or wireless Internet and offered with a web page 10. The user client 100 is connected to the web server 200 to receive information on a TCP socket server 300 such as Internet protocol (IP) address or a port number, and the user client 100 is connected to the TCP socket server 300 by using the received information on the TCP socket server 300.

If there is no firewall between the user client 100 and the TCP socket server 300, the user client 100 communicates with an operator client 400 through the TCP socket server 300 and transmits and receives messages inputted to a chatting window displayed on the web page 10 to/from the operator client 400.

However, if a TCP socket connection between the user client 100 and the TCP socket server 300 is blocked by a firewall, the web server 200 generates a session with respect to the user client 100 and assigns an ID for the user client 100.

The user client 100 communicates with the web server 200 by using the generated session and sends the messages inputted to the chatting window displayed on the web page 10 to the web server 200.

Further, the user client 100 receives messages inputted by the operator client 400 from the web server 200, displays the received messages on a screen, and participates in online chatting with the operator client 400.

The web server 200 is connected to the user client 100, generates an ID (identification) of the user client 100, and generates a session including the generated ID with respect to the user client 100.

By way of example, the ID generated by the web server 200 may be stored in userData file or flash data file in the user client 100.

The web server 200 receives chatting messages inputted by the user client 100 and the ID of the user client 100, and stores the received chatting messages and the ID in the database. Further, the web server 200 receives chatting messages inputted by the operator client 400 and the ID of the user client 100, and stores the received chatting messages and the ID of the user client 100 in the database.

The user client 100 periodically receives the periodically stored chatting messages related to its own ID from the database. Further, the operator client 400 also periodically receives the chatting messages related to the ID of the user client 100 from the database.

Meanwhile, the TCP socket server 300 transmits the messages inputted to the chatting window of the web page 10 by the user client 100 to the operator client 400 and transmits messages inputted to the chatting window of the web page 10 by the operator client 400 to the user client 100.

The operator client 400 is notified of connection of the user client 100 by the web server 200 and transmits the chatting messages inputted to the chatting window of the web page 10 by the operator to the web server 200. Further, the operator client 400 receives the messages inputted by the user client 100 from the web server 200 and displays the received messages on a screen.

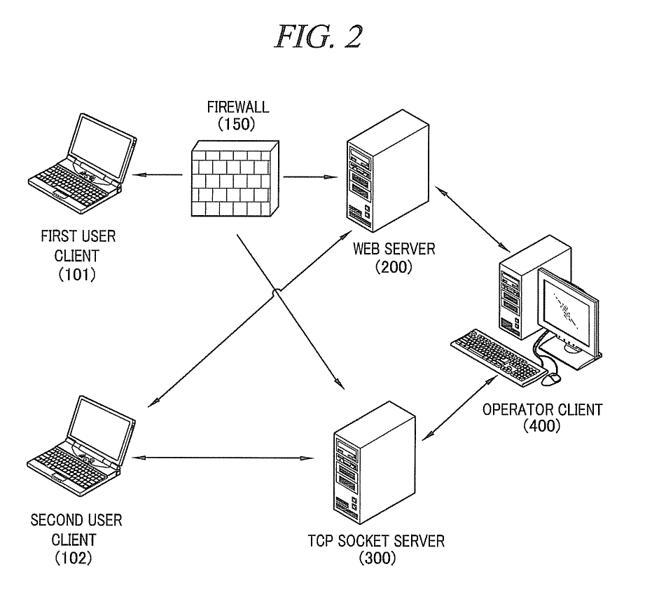

FIG. 2 shows a system which provides online chatting to a user connected to a website depending on whether or not there is a firewall in accordance with an embodiment of the present disclosure.

Generally, a firewall 150 blocks most ports except a HTTP connection port for Internet connection, e.g., a HTTP port 80. Therefore, a TCP connection between a first user client 101 and the TCP socket server 300 is blocked by the firewall 150.

Accordingly, the first user client 101 is prevented by the firewall 150 from being connected to the TCP socket server 300, and is connected to the web server 200 through the non-blocked connection port and transmits the chatting messages inputted to the chatting window of the web page 10 to the web server 200. Further, the first user client 101 periodically receives the chatting messages stored in the database through the web server 200 and displays them on the chatting window. The database storing therein the chatting messages may be included in the web server 200 or in another separate server other than the web server 200.

A second user client 102 is not blocked by the firewall 150, and, thus, it can be connected to the TCP socket server 300. Therefore, the second user client 102 is connected to the web server 200 and is provided with the web page 10 including the chatting window, and receives information on the TCP socket server 300. The second user client 102 can be connected to the TCP socket server 300 by using the received information on the TCP socket server 300, and the second user client 102 can perform a real-time online chat with the operator client 400 through the TCP socket server 300.

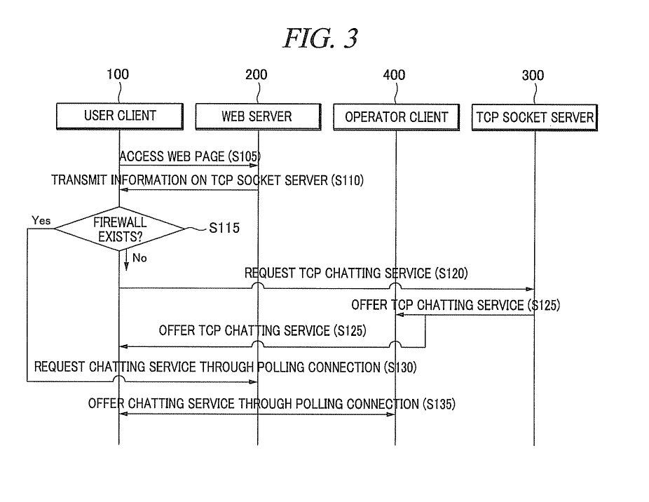

FIG. 3 is a flowchart showing an online chatting method for a user connected to a website in accordance with an embodiment of the present disclosure.

In step S105, the user client 100 is connected to the web server 200 and is connected to a web page provided by the web server 200. The web page provided by the web server 200 includes a chatting window where a chat with the operator client 400 is inputted and displayed.

In step S110, the web server 200 provides information on the TCP socket server 300 for a real-time online chatting with the operator client 400 to the user client 100 in response to the connection of the user client 100. The information on the TCP socket server 300 may include an IP address and a port number of the TCP socket server 300.

Further, the web server 200 may provide information on the operator client 400, which is the other party of the online chatting to the user client 100.

In step S115, the user client 100 determines whether or not there is a firewall between the user client 100 and the TCP socket server 300 in order to communicate with the TCP socket server 300 corresponding to the information received in step S110, and determines whether or not communication with the TCP socket server 300 is blocked by the firewall.

Generally, the firewall blocks communication with the TCP socket server 300 through any random port, and, thus, if there is the firewall, most of the communication between the user client 100 and the TCP socket server 300 may be blocked.

In step S120, if it is determined that there is no firewall between the user client 100 and the TCP socket server 300 in step S115, the user client 100 is connected to the TCP socket server 300 by using the information on the TCP socket server 300 received in step S110.

The user client 100 is connected to the TCP socket server 300 so as to request a real-time online chatting with the operator client 400. The user client 100 can make a request for a real-time online chatting with the operator client 400 by providing the information on the operator client 400 received from the web server 200 to the TCP socket server 300.

In step S125, the TCP socket server 300 provides the real-time online chatting between the user client 100 and the operator client 400 in response to the request received in step S120. The real-time online chatting between the user client 100 and the operator client 400 is made through a certain port and a chatting window where the chatting messages are inputted and displayed is displayed by a script included in the web page provided by the web server 200. Therefore, the real-time online chatting can be provided without a program installation.

Further, if necessary, the TCP socket server 300 may store the chatting messages between the user client 100 and the operator client 400 in a separate database and may provide the stored chatting messages when there is a request of the user client 100 or the operator client 400 therefor at a later time.

Such an online chatting through the TCP socket server is made only when a message is inputted. Therefore, it is possible to reduce unnecessary load.

Furthermore, in the online chatting through the TCP socket server 300, if the message is inputted, a response thereto can be made immediately. Therefore, it is possible to provide a faster real-time online chatting service.

In step S130, if it is determined that there is a firewall between the user client 100 and the TCP socket server 300 in step S115, the user client 100 requests an online chatting through a polling connection to the web server 200.

In step S135, the web server 200 provides the online chatting between the user client 100 and the operator client 400 through the polling connection in response to the request of the user client 100 in step S130.

The online chatting through the polling connection is performed by the web server 200, and the user client 100 and the web server 200 communicate with each other through a HTTP connection port such as a HTTP port 80, which is not blocked by the firewall. Therefore, the online chatting through the polling connection can be provided without any influence of the firewall.

An online chatting method through a polling connection between the user client 100 and the operator client 400 will be explained in detail below.

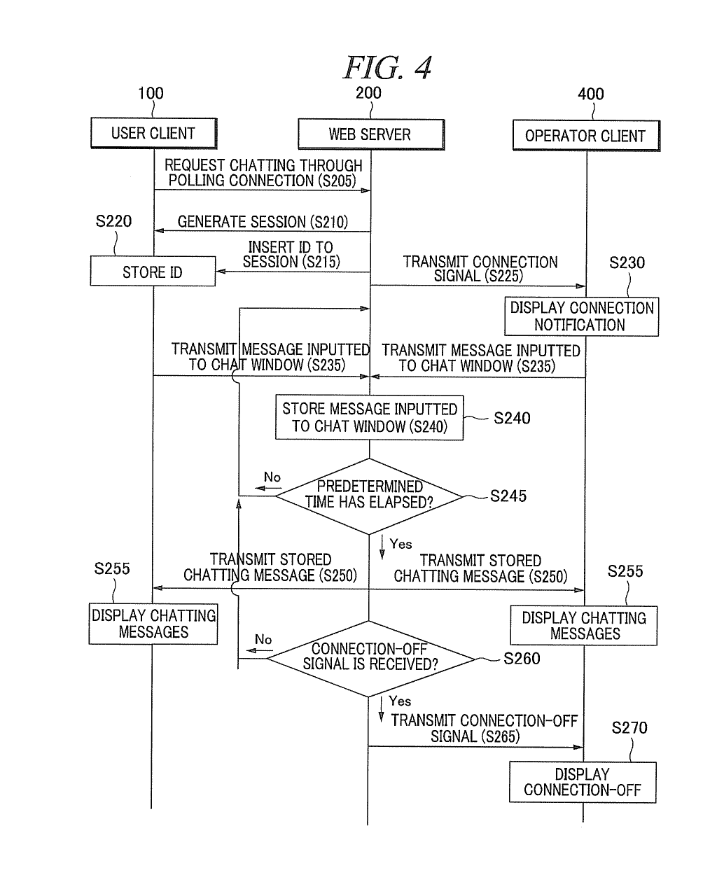

FIG. 4 is a flowchart showing an online chatting method through a polling connection in accordance with an embodiment of the present disclosure.

In step S205, the user client 100 requests an online chatting through a polling connection to the web server 200. The user client 100 may be connected to the web server 200 through a HTTP connection port such as a HTTP port 80. The HTTP connection port is a port for communication with a certain web server through the Internet, and generally, it is not blocked by the firewall.

In step S210, the web server 200 generates a session with respect to the user client 100 in response to the request received in step S205.

The session is a logical connection for communication between the user client 100 and the web server 200 in a network environment, and the web server 200 generates a session with respect to the user client 100 for communication with the user client 100.

In step S215, the web server 200 inserts an ID into the session generated with respect to the user client 100 in step S210.

For example, if a session has a value of “1234xxx”, the web server 200 may insert an ID of “aaa” to the session of “1234xxx” and may create a value of “1234xxxaaa”.

In step S220, the user client 100 stores therein information on the ID assigned by the web server 200 in step S215. The user client 100 may store the ID in userData file or in flash data file.

Here, the userData file stores basic minimum information which can be automatically downloaded by a user client from a web browser. The userData file is stored in a position different form a position where the cookie is stored and has a more flexible structure and a larger capacity as compared to the cookie.

In other words, the userData file is one of Internet temporary files containing information to be updated in the user client 100, but the userData file may have a much larger capacity of about 1 MB than the cookie's general capacity of about 1 KB. Further, the userData file is an extensible markup language (XML) file whereas the cookie is a text file.

The userData file in the present disclosure may be written or read by using userData Behavior which is a kind of function provided by Microsoft Corporation to be used in its web browser, i.e., Internet Explorer. More details can be found at “http://msdn2.microsoft.com/en-us/library/ms531424.aspx.”

The flash data file is configured to store data in the user client 100 and can be read by using SharedObject embedded class of Macromedia Flash.

The flash data file does not include a cookie generally used in a java script or a server site script (e.g., php, asp, and jsp). However, the flash data file is configured to store data in the user client 100.

The flash data file stores data in a Flash SWF file by using the SharedObject class of the Macromedia Flash. The SharedObject makes a reference to a shared object which is permanently stored in a local position and can be used only by a current client. In case that the SharedObject class cannot generate a reference to a shared object or search for a shared object, a getLocal( ) function returns a null.

A storage path is, for example, “C:\Documents and Settings\Administrator\ApplicationData\Macromedia\FlashPlayer\#SharedObjects”. Further, although a cookie of a general browser has a maximum storage size of about 4 KB, a basic storage size of the flash data file may be about 100 KB, and the storage size may be indefinite and can be set by a user.

As described above, data or information can be stored in the userData file or the flash data file in the user client 100, and, thus, the user client 100 can store its ID in the userData file or the flash data file.

In step S225, the web server 200 transmits a connection signal including an ID and a session generated by a connection of the user client 100 to the operator client 400.

In step S230, the operator client 400 displays a connection notification on its screen by using the connection signal received in step S225. The connection notification can be made in the form of an audio alarm or a pop-up message. The operator client 400 can display the connection notification and a chatting window with the user client 100 on the screen at the same time.

In step S235, the user client 100 transmits chatting messages inputted to a chatting window by the user to the web server 200. A web page to which the user client 100 is connected provides a chatting window to the user client 100 regardless of login of the user. Since the provided chatting window is displayed on a web page by a script, it can be provided without installing a separate program.

Therefore, the user can input the chatting messages to the chatting window provided by the web site, and the user client 100 transmits the inputted chatting messages to the web server 200. Further, the operator client 400 transmits the chatting messages inputted by the operator to the web server 200.

In this case, the user client 100 and the operator client 400 may transmit an ID, for example, “aaa”, of the user client 100 together with the chatting messages to the web server 200.

Although it is described in an embodiment of the present disclosure that the user client 100 and the operator client 400 transmits the chatting messages at the same time, the present disclosure is not limited thereto and they may transmit the chatting messages separately for a predetermined time period.

In step S240, the web server 200 stores the chatting messages received from the user client 100 and the operator client 400 in the database. The web server 200 identifies an ID relevant to the chatting messages and a user client corresponding to the ID by using the ID received together with the chatting messages, and stores the received chatting messages together with a relevant ID.

For example, if the user client 100 is assigned an ID of “aaa” and the web server 200 stores the contents of the chatting between the user client 100 and the operator client 400, the web server 200 can store the chatting messages so as to correspond to the ID “aaa.”

In step S245, the web server 200 determines whether or not a predetermined time has elapsed. That is, the web server 200 determines whether or not a predetermined time, e.g., 3 seconds, has elapsed since the connection of the user client 100 to the web page or whether or not a predetermined time has elapsed since the transmission of the chatting messages to the user client 100 and the operator client 400.

In step S250, if it is determined that the predetermined time has elapsed in step S245, the web server 200 transmits the chatting messages stored in step S240 to the user client 100 and the operator client 400.

The chatting messages transmitted by the web server 200 will be stored together with the ID of the user client 100 as described above.

Although it is described in an embodiment of the present disclosure that the web server 200 transmits the chatting messages stored in the web server 200 to the user client 100 and the operator client 400 at the same time, the present disclosure is not limited thereto and the web server 200 may transmit the chatting messages to the client 100 and the operator client 400 at different times from each other.

Further, each of the user client 100 and the operator client 400 may request the stored chatting messages to the web server 200 and receive the stored chatting messages from the web server 200 periodically, and the stored chatting messages may be transmitted to the user client 100 and the operator client 400 by the web server 200 at the same time or at different times from each other.

In step S255, the user client 100 and the operator client 400 displays the chatting messages received from the web server 200 on the chatting window. The chatting messages displayed by the user client 100 and the operator client 400 may include all the chatting messages received by the web server 200 from the user client 100 and the operator client 400. If the predetermined time interval is short enough in step S245, the user and the operator can obtain the same effect of a real-time online chatting.

Furthermore, the operator client 400 displays the received chatting messages on a chatting window corresponding to the ID of the user client 100. The operator client 400 displays the chatting messages received in step S245 on a chatting window created for an online chatting with the user client 100 among one or more chatting windows.

In step S260, the web server 200 determines whether or not a connection-off signal is received from the user client 100. That is, the web server 200 determines whether or not the user client 100 closes a connection to the web site provided by the web server 200.

In step S265, if it is determined that the connection-off signal is received from the user client 100, the web server 200 transmits the connection-off signal of the user client 100 to the operator client 400. The connection-off signal of the user client 100 transmitted by web server 200 may include the ID of the user client 100.

In step S270, the operator client 400 displays that the user client 100 closed the connection on the chatting window corresponding to the ID of the user client 100 in response to the connection-off signal received in step S265.

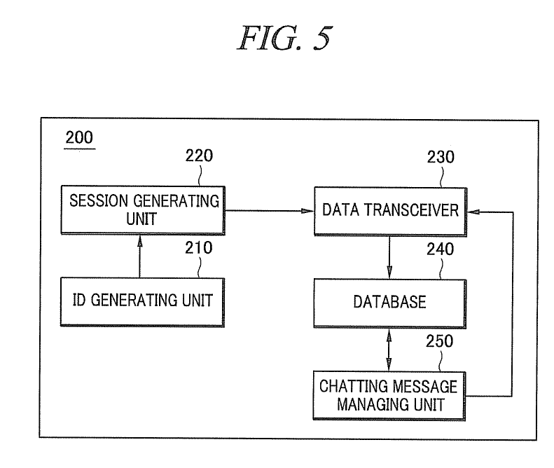

FIG. 5 is a block diagram showing a configuration of a web server of an online chatting system for a user connected to a website in accordance with an embodiment of the present disclosure.

The web server 200 in accordance with an embodiment of the present invention includes an ID generating unit 210, a session generating unit 220, a data transceiver 230, a database 240, and a chatting message managing unit 250.

The ID generating unit 210 generates an ID (identification) corresponding to a user client (omitted from the illustration) connected to a web page provided by the web server 200. The ID generating unit 210 transmits the generated ID to the session generating unit 220.

The session generating unit 220 generates a session between the user client connected to the web page and the web server 200, receives the ID of the user client from the ID generating unit 210, and inserts information on the received ID into the session between the user client and the web server 200.

For example, if the session between the user client and the web server 200 is “1234xxx”, the web server 200 may assign an ID of “aaa” to the session of “1234xxx” and may create a value of “1234xxxaaa” including the session and the ID.

The data transceiver 230 transmits and receives data between the web server 200 and the user client. To be more specific, the data transceiver 230 receives a web page connection signal from the user client and transmits information on session generation to the user client. The data transceiver 230 transmits the connection signal of the user client together with the ID of the user client to an operator client.

Further, the data transceiver 230 receives chatting messages from the user client and the operator client, receives chatting messages stored in the database 240 through the chatting message managing unit 250, and transmits the stored chatting messages to the user client and the operator client.

The database 240 stores information on a session and an ID of the user client and stores the chatting messages received from the user client and the operator client together with the ID of the user client.

The chatting message managing unit 250 receives the chatting messages made during a predetermined time period from the database 240 and transmits the received chatting messages to the user client and the operator client through the data transceiver 230.

That is, the chatting message managing unit 250 receives periodically the chatting messages stored for each ID during the predetermined time period from the database 240, and transmits the received chatting messages and the ID to the data transceiver 230 so as to transmit them to the user client corresponding to the chatting messages.

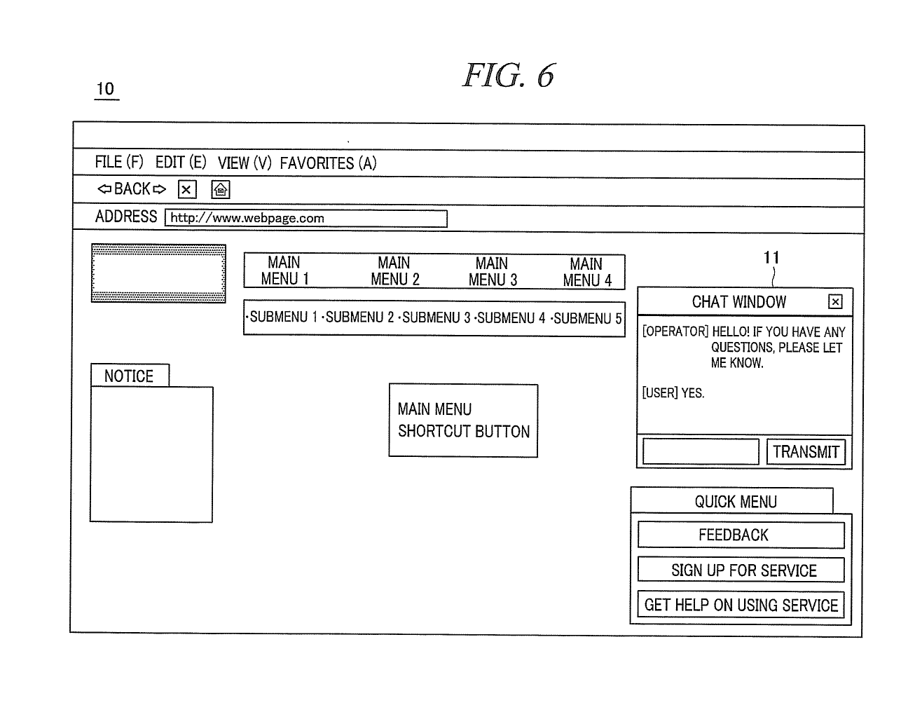

FIG. 6 shows a screen of a website in which online chatting function is provided to a user and displayed on a browser of a user client in accordance with an embodiment of the present disclosure.

If a user client (omitted from the illustration) is connected to the web page 10, an ID of the user client and a session between the web server and the user client are generated and the web page 10 including the chatting window is displayed on a screen of the user client. The chatting window 11 can be displayed by a script included in the web page.

A user inputs chatting messages to the chatting window 11 displayed on the screen of the user client and transmits the inputted chatting messages to a TCP socket server (omitted from the illustration) or a web server (omitted from the illustration) of the web page. The chatting window 11 displays the chatting messages inputted by an operator client and the user client in a sequence of time.

The chatting window 11 displayed on the web page 10 can be implemented in the web page and displayed on the screen of the user client without installing a separate program.

The embodiment of the present invention can be embodied in a storage medium including instruction codes executable by a computer such as a program module executed by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

The system and method of the present invention has been explained in relation to a specific embodiment, but its components or a part or all of its operation can be embodied by using a computer system having general-purpose hardware architecture.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention. For example, each component described to be of a single type can be implemented in a distributed manner. Likewise, components described to be distributed can be implemented in a combined manner.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. An online chatting method for a user connected to a website, the method comprising:
(a) receiving information on a TCP socket server by a user client when the user client accesses a web page offered by a web server;
(b) accessing the TCP socket server by the user client by using the information on the TCP socket server;
(c) if the user client is allowed to access the TCP socket server, transmitting and receiving chatting messages to/from an operator client through the TCP socket server; and
(d) if the user client fails to access the TCP socket server, storing the chatting messages to be transmitted to the operator client through in a database and periodically receiving the chatting messages stored in the database by the operator client,
wherein the information on the TCP socket server includes an IP (Internet Protocol) address and a port number of the TCP socket server.

2. The online chatting method of claim 1, wherein a chatting window where the chatting messages are inputted is displayed on the web page by a script inserted into the web page.

3. The online chatting method of claim 1, wherein the step (d) includes:
(d1) receiving an ID (Identification) from the web server;
(d2) transmitting the ID and the chatting messages to the web server; and
(d3) periodically receiving the chatting messages which are related to the ID and stored in the database by the operator client.

4. The online chatting method of claim 3, wherein the ID is inserted into a session of the user client and is assigned to the user client.

5. The online chatting method of claim 3, wherein the ID is stored in userData file which is configured to store data in the user client and to read the stored data from the user client by using userData Behavior.

6. The online chatting method of claim 3, wherein the ID is stored in flash data file which is configured to store data in the user client and to read the stored data from the user client by using SharedObject class of Macromedia Flash.

7. An online chatting system for a user connected to a website, the system comprising:
a TCP socket server connected to a user client and an operator client through a predetermined port; and
a web server connected to the user client and the operator client through a HTTP connection port,
wherein, if a connection between the user client and the TCP socket server is not blocked by a firewall, the user client and the operator client perform an online chatting by exchanging chatting messages in real time through the TCP socket server,
if a connection between the user client and the TCP socket server is blocked by the firewall, each of the user client and the operator client stores chatting messages in a database, and each of the operator client and the user client periodically receives the chatting messages stored in the database, and
the web server provides information on the TCP socket server including an IP address and a port number of the TCP socket server to the user client.

8. The online chatting system of claim 7, wherein the web server includes:
an ID (identification) generating unit that generates an ID corresponding to the user client;
a database that stores the chatting messages received from the user client and the operator client, together with the ID; and
a chatting message managing unit that periodically provides the chatting messages stored in the database to the user client and the operator client.

9. The online chatting system of claim 8, further comprising:
a session generating unit that generates a session with respect to the user client and inserts the ID into the session.

10. The online chatting system of claim 8, wherein the ID is stored in userData file which is configured to store data in the user client and to read the stored data from the user client by using userData Behavior.

11. The online chatting system of claim 9, wherein the ID is stored in flash data file which is configured to store data in the user client and to read the stored data from the user client by using SharedObject class of Macromedia Flash.
